(19) United States
(12) Patent Application Publication
(10) Pub. No.: US 2023/0109231 A1
(43) Pub. Date: Apr. 6, 2023

(54) CUSTOMIZABLE NETWORK VIRTUALIZATION DEVICES USING MULTIPLE PERSONALITIES

(71) Applicant: Oracle International Corporation, Redwood Shores, CA (US)

(72) Inventors: Eden Adogla, Seattle, WA (US); Brijesh Singh, Mercer Island, WA (US)

(73) Assignee: Oracle International Corporation, Redwood Shores, CA (US)

(21) Appl. No.: 17/930,828

(22) Filed: Sep. 9, 2022

Related U.S. Application Data
(60) Provisional application No. 63/262,057, filed on Oct. 4, 2021.

(51) Int. Cl. H04L 41/0895; H04L 41/40

(52) U.S. Cl. CPC H04L 41/0895; H04L 41/40

(57) ABSTRACT

Techniques are described for changing and customizing the functional behavior of a network virtualization device (NVD) using multiple different personalities. The disclosed techniques enable a network device such as an NVD to be configured and reconfigured during its lifetime to support different functional behaviors in an easy and convenient manner. In certain embodiments, this is accomplished through the use of personalities. During the lifetime of an NVD, different personalities may be associated with or bound to an NVD, where the personality bound to a NVD determines the capabilities or functional behavior of the NVD. By changing the personalities bound to an NVD, the functional behavior, characterized by a set of functions that the NVD can perform, can be changed.

### CROSS-REFERENCE TO RELATED APPLICATION

This application is a non-provisional of and claims priority to U.S. Provisional Application No. 63/262,057 filed on Oct. 4, 2021 and entitled “Customizable Network Virtualization Devices Using Multiple Personalities,” the entire contents of which are incorporated herein by reference for all purposes.

### TECHNICAL FIELD

This disclosure generally relates to network virtualization devices (NVDs). More specifically, but not by way of limitation, this disclosure describes techniques for changing and customizing the functional behavior of an NVD using multiple different personalities.

### BACKGROUND

In order to provide cloud services, a Cloud Service Provider (CSP) has to provide and maintain a huge cloud infrastructure (e.g., hardware, and software components) that is used to provide the cloud services. These cloud services may be provided under different models such as Software-as-a-Service (SaaS) model, Platform-as-a-service (PaaS) model, Infrastructure-as-a-Service (IaaS) model, and others. The CSP infrastructure can include various devices such as servers or host machines that execute compute instances (e.g., virtual machines), NVDs (e.g., one or more devices including but not limited to NICs and storage devices, wherein, in some instances, a single NVD may include multiple such devices) connected to the host machine that are configured to provide network virtualization functionalities, network components such as various switches and routers, and the like. In a typical scenario, when a device is ingested into a cloud infrastructure (e.g., into a data center provided by the CSP), the device is configured at that point based upon the functions the device is supposed to perform and/or the environment in which the device is supposed to operate. For example, if a server and an associated NVD are configured to be used in the physical network (e.g. substrate network) the server and the NVD are configured in a particular manner. However, if the server and the NVD are to be provisioned to support the virtual network or the overlay network, they may be provisioned in a different manner. The problem with existing CSP infrastructures is that once a device (e.g., an NVD) is configured in a certain manner, reconfiguration of the device is not possible or not performed. In some instances, a network administrator may be able to manually re-provision a device, but this process, due to its manual nature, is very tedious and complicated because substrate and overlay networks are configured to be mutually distrusting so that a security posture of either network by simply forbidding use of a card inside both networks or in aid of both networks. As a result, in most cloud infrastructures, once provisioned, a device remains with the same configuration throughout its lifetime.

### SUMMARY

The present disclosure describes techniques for changing and customizing the functional behavior of an NVD using multiple different personalities. Techniques are described that enable a network device such as an NVD to be configured and reconfigured during its lifetime to support different functional behaviors in an easy and convenient manner. In certain embodiments, this is accomplished through the use of personalities. During the lifetime of an NVD, different personalities may be associated with or bound to an NVD, where the personality bound to a NVD determines the capabilities or functional behavior of the NVD. Various embodiments are described herein, including methods, systems, non-transitory computer-readable storage media storing programs, code, or instructions executable by one or more processors, and the like.

As an example, when an NVD is first provisioned, the NVD may need to be configured to provide a particular functional behavior. To enable this, a first personality that provides the desired particular functional behavior may be bound or associated with the NVD. Subsequently, it may be desired that the functional behavior of the NVD to be changed to provide a changed functionality. To enable this, the first personality may be removed from the NVD and a second personality corresponding to the changed functional behavior may be bound to the NVD. In this manner, the capabilities and functionality of a NVD can be changed during its lifetime by changing the personality that is associated or bound to the NVD.

As indicated above, a particular personality that is bound to an NVD determines the functional behavior of that NVD, where the functional behavior is characterized by a set of functions that the NVD can perform. In certain embodiments, each personality includes or is characterized by (a) a software or firmware image, (b) a set of configurations, and (c) an identity.

Different personalities may be defined, each with a different combination of different firmware images, configurations, and identities. Different personalities may be defined corresponding to different sets of functions. For example, a first personality may be defined for a first set of functions, a second personality may be defined for a second set of functions, a third personality may be defined for a third set of functions, and so on. Accordingly, the functionality of an NVD can be changed by changing the personality bound to the NVD. This offers tremendous flexibility in being able to change the functional behavior of an NVD over its lifetime. The same NVD can now be configured and reconfigured to support different sets of functions for different use cases or environments.

Certain embodiments involve binding a particular personality selected from a set of personalities to an NVD and provisioning the NVD. For example, the NVD management system (NMS) determines, from a set of personalities, a first personality to be bound to an NVD. The NMS unbinds a second personality bound to the NVD, wherein the second personality defines a second identity for the NVD associated with a second set of policies and privileges. The NMS binds the first personality to the NVD, wherein the first personality defines a first identity for the NVD associated with a first set of policies and privileges. The NMS provisions the NVD by associating the NVD with a host machine.

In certain embodiments, techniques are provided for binding different personalities to an NVD. A first personality is bound to a network virtualization device (NVD), the first personality causing the NVD to have a first functional behavior characterized by a first set of functions, wherein the first set of functions include a first network virtualization function. At some subsequent time, the first personality is unbound from the NVD, and a second personality is bound to the NVD, wherein the second personality causes the NVD to have a second functional behavior characterized by a second set of functions, the second set of functions including a second wherein the second set of functions includes a second network virtualization function, and wherein the second set of functions is different from the first set of functions.

In certain embodiments, the first personality may include a first firmware image and the second personality may include a second firmware image, wherein the first firmware image is different from the second firmware image.

In certain embodiments, the first personality may include first configuration information specifying a first set of values for a first set of configuration parameters, and the second personality may include second configuration information specifying a second set of values for a second set of configuration parameters, and wherein the first configuration information is different from the second configuration information.

In certain embodiments, the first personality may include a first identity associated with a first set of privileges, and the second personality may include a second identity associated with a second set of privileges, and wherein the first set of privileges is different from the second set of privileges.

In certain embodiments, information may be received identifying the first personality to be bound to the NVD. In some other embodiments, the method of claim 21 further comprising information may be received identifying an environment in which the NVD is to operate, and, based upon the environment, the first personality to be bound to the NVD may be identified where the first personality provides a functional behavior that is suited for the identified environment. In some other embodiments, information may be received identifying a first functional behavior for the NVD, and based upon the first functional behavior, a first personality that provides the first functional behavior is selected to be bound to the NVD.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a high level diagram of a distributed environment showing a virtual or overlay cloud network hosted by a cloud service provider infrastructure (CSPI), according to certain embodiments.

FIG. 2 depicts a simplified architectural diagram of the physical components in the physical network within a CSPI according to certain embodiments.

FIG. 3 shows an example arrangement within a CSPI where a host machine is connected to multiple network virtualization devices (NVDs) according to certain embodiments.

FIG. 4 depicts connectivity between a host machine and an NVD for providing I/O virtualization for supporting multitenancy according to certain embodiments.

FIG. 5 depicts a simplified block diagram of a physical network provided by a CSPI according to certain embodiments.

FIG. 6 depicts a computing environment for binding a particular personality selected from a set of personalities to an NVD and provisioning the NVD, according to certain embodiments.

FIG. 7 depicts a method for binding a particular personality selected from a set of personalities to an NVD and provisioning the NVD, according to certain embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure describes techniques for changing and customizing the functional behavior of an NVD using multiple different personalities. Techniques are described that enable a network device such as an NVD to be configured and reconfigured during its lifetime to support different functional behaviors in an easy and convenient manner. In certain embodiments, this is accomplished through the use of personalities. During the lifetime of an NVD, different personalities may be associated with or bound to an NVD, where the personality bound to a NVD determines the capabilities or functional behavior of the NVD. Various embodiments are described herein, including methods, systems, non-transitory computer-readable storage media storing programs, code, or instructions executable by one or more processors, and the like.

The problem with existing CSP infrastructures is that once a device (e.g., an NVD) is configured in a certain manner, reconfiguration of the device is not possible or not performed. The configuration for a device, and hence its functional behavior, is statically set for the lifetime of the device. This prevents infrastructure components from being reused for different purposes. The various embodiments described in this disclosure enable such devices, and especially NVDs, to be reconfigured multiple times during their lifetime to provide different functional behaviors. The same NVD can then be used and reused for different uses cases and in different environments with different functional behaviors suited for those use cases or environments.

As an example, when an NVD is first provisioned, the NVD may need to be configured to provide a particular functional behavior. To enable this, a first personality that provides the desired particular functional behavior may be bound or associated with the NVD. Subsequently, it may be desired that the functional behavior of the NVD to be changed to provide a changed functionality. To enable this, the first personality may be removed or unbound from the NVD and a second personality corresponding to the changed functional behavior may be bound to the NVD. In this manner, the capabilities and functionality of a NVD can be changed during its lifetime by changing the personality that is associated or bound to the NVD.

As indicated above, a particular personality that is bound to an NVD determines the functional behavior of that NVD, where the functional behavior is characterized by a set of functions that the NVD can perform. In certain embodiments, each personality includes or is characterized by (a) a software or firmware image, (b) a set of configurations, and (c) an identity. The firmware image for a personality may include a certain set of programs, applications, codes, or instructions providing certain functionality. Different personalities may have different associated firmware images. Accordingly, the functions enabled by different firmware images may be different.

The set of configurations defined for a personality may specify a specific set of configuration parameters and associated values, where these configuration parameters influence the functioning of the NVD or components of the NVD. For example, with respect to the ports on an NVD, the configuration information defined for a personality may specify parameters and associated values that control the number of active ports of the NVD, which ports are to be active, the bandwidths configured for the ports, which ports are to be uplink ports versus downlink ports, and the like. Configuration settings may also be defined for other aspects of the NVD such as storage configurations for the NVD such as the amount of available storage, number of NVMe/storage or PCIe physical and virtual functions to expose, and the like.

A personality may also have an associated identity. In certain embodiments, there is a one-to-one correspondence between personalities and identities, with each personality having its own unique identity. These identities may be used by an identity management system for authentication and authorization purposes. In certain embodiments, a set of policies may be defined for each identity, where the set of policies defines a set of privileges for that identity. In certain embodiments, the set of policies/privileges defined for an identity control what resources can be accessed by the identity and what operations or functions can be performed by or for the identity. When a personality is bound to an NVD, the NVD assumes the identity that is associated with the personality and the NVD gets the privileges associated with that identity. Accordingly, changing the personality bound to an NVD results in a change in the identity that is assumed by the NVD, which in turn may change the access privileges for the NVD. As the personalities bound with an NVD change over the lifetime of the NVD, the identity-based privileges for the NVD also change corresponding to the bound personalities.

In certain embodiments, an identity management system is configured to control and resolve identity related issues. For example, the identity management system may perform authentication and authorization processing for an NVD based upon the personality bound to the NVD and the identity defined for that personality. In response to a request generated by an NVD to perform a particular function or to access a particular resource, the identity management system may determine the personality that is currently bound to the requesting NVD and determine the corresponding identity. The identity management system may then determine, based on policies associated with the identity, a set of privileges defined for that identity, and based upon the determined privileges, determine whether the NVD is authorized to perform the particular function or access the particular resource specified in the request. In this manner, by enabling personalities associated with an NVD to be changed during the lifetime of the NVD, different identities are associated with the NVD, which in turn causes changes in the privileges for that NVD, which in turn changes the functional behavior of the NVD.

Different personalities may be defined, each with a different combination of different firmware images, configurations, and identities. Different personalities may be defined corresponding to different sets of functions. For example, a first personality may be defined for a first set of functions, a second personality may be defined for a second set of functions, a third personality may be defined for a third set of functions, and so on. Accordingly, the functionality of an NVD can be changed by changing the personality bound to the NVD. This offers tremendous flexibility in being able to change the functional behavior of an NVD over its lifetime. The same NVD can now be configured and reconfigured over its lifetime to support different sets of functions for different use cases or environments.

While examples in the present disclosure describe a personality as including a firmware image, configuration information specifying a set of configuration parameters and their associated values, and an identity, this is not intended to be limiting. In various embodiments, a personality may include only a firmware image, only configuration information, only an identify, or various combinations thereof. According to the teachings of the present disclosure, an NVD can be configured and reconfigured during its lifetime to support different functional behaviors through the use of personalities. During the lifetime of an NVD, different personalities may be associated with or bound to an NVD, where the personality bound to a NVD determines the capabilities or functional behavior of the NVD.

Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

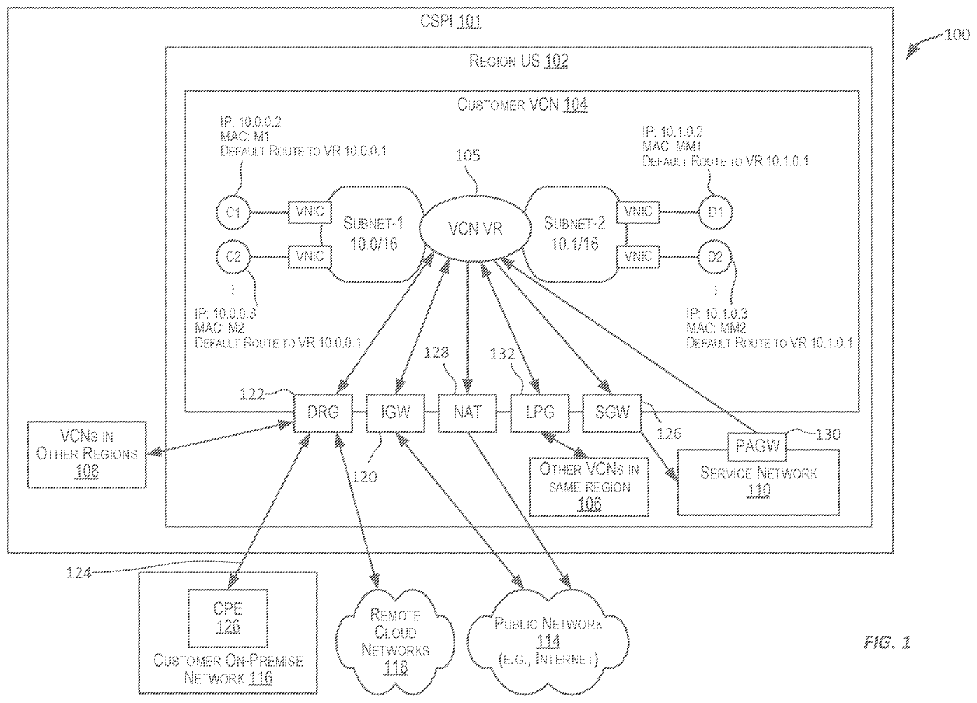

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

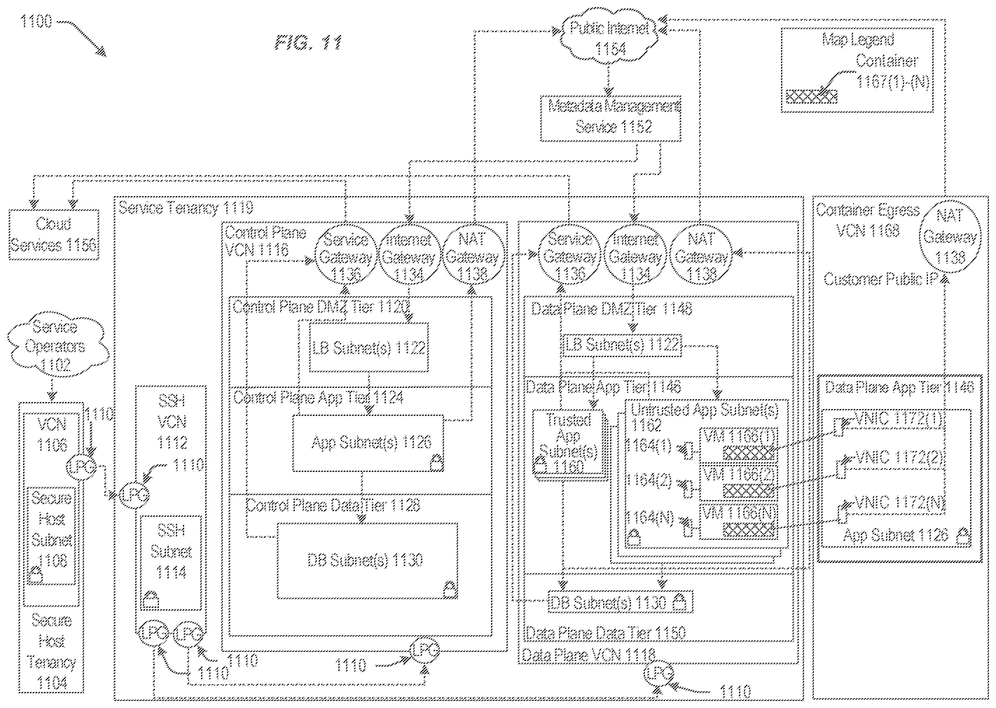

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 11, 12, 13, and 14 (see references 816, 916, 1016, and 1116) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, 11, 12, 13, 14, and 15 and are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router (VCN VR) 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VCN VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of C1. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 11, 12, 13, and 14 (for example, gateways referenced by reference numbers 834, 836, 838, 934, 936, 938, 1034, 1036, 1038, 1134, 1136, and 1138) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

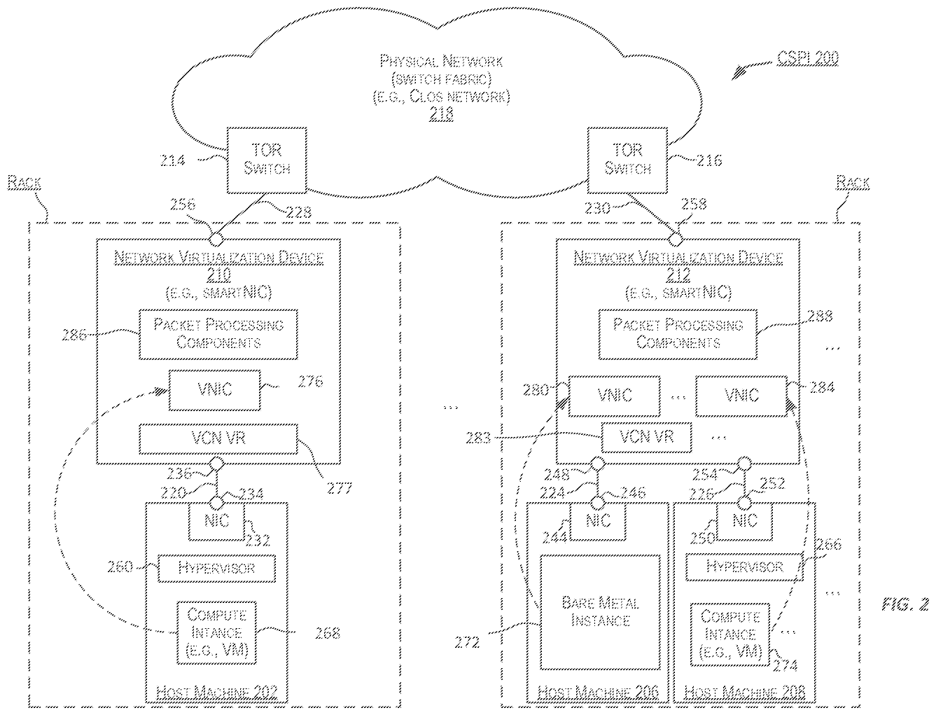

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

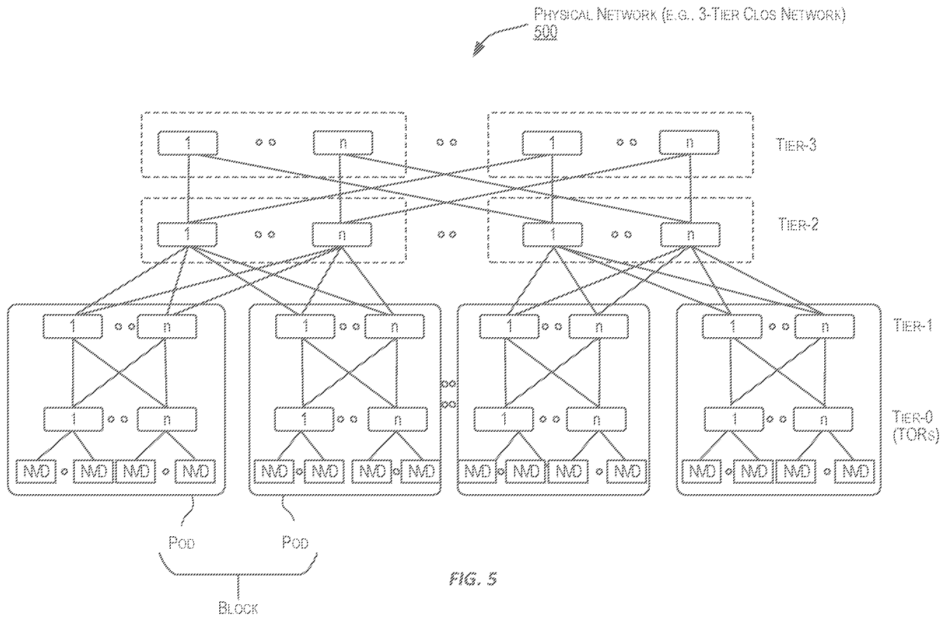

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

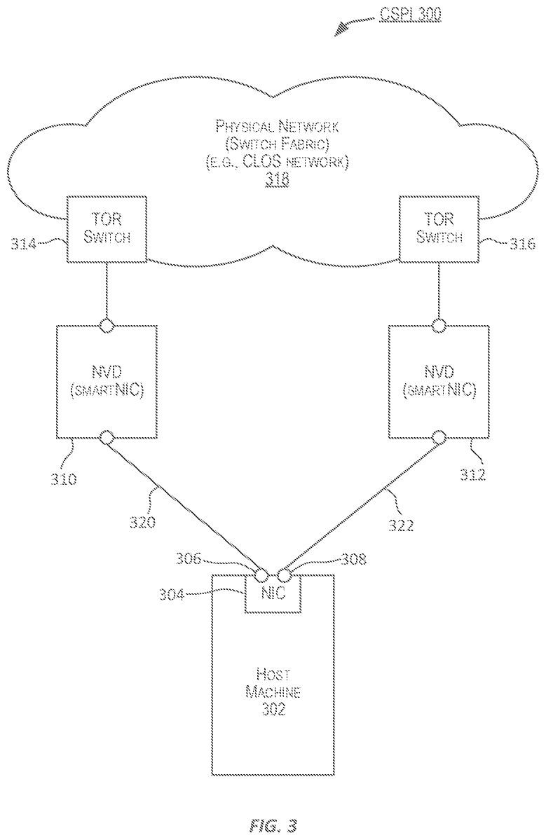

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320, and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 11, 12, 13, and 14 (see references 816, 916, 1016, and 1116) and described below. Examples of a VCN Data Plane are depicted in FIGS. 11, 12, 13, and 14 (see references 818, 918, 1018, and 1118) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2, NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

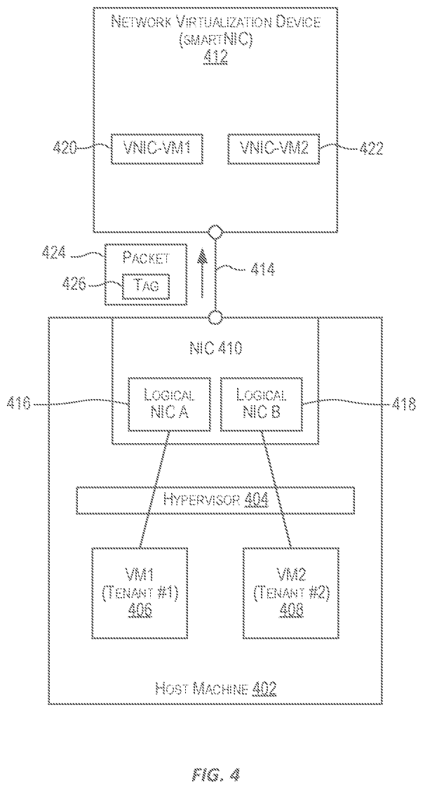

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2. Host machine 402 comprises a physical NIC 410 that is connected to an NVD 412 via link 414. Each of the compute instances is attached to a VNIC that is executed by NVD 412. In the embodiment in FIG. 4, VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example, VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>. [REGION][.FUTURE USE].<UNIQUE ID>
   where,
   ocid1: The literal string indicating the version of the CID;
   resource type: The type of resource (for example, instance, volume, VCN, subnet, user, group, and so on);
   realm: The realm the resource is in. Example values are “c1” for the commercial realm, “c2” for the Government Cloud realm, or “c3” for the Federal Government Cloud realm, etc. Each realm may have its own domain name;
   region: The region the resource is in. If the region is not applicable to the resource, this part might be blank;
   future use: Reserved for future use.
   unique ID: The unique portion of the D. The format may vary depending on the type of resource or service.

Reconfiguration of NVDs using Multiple Personalities

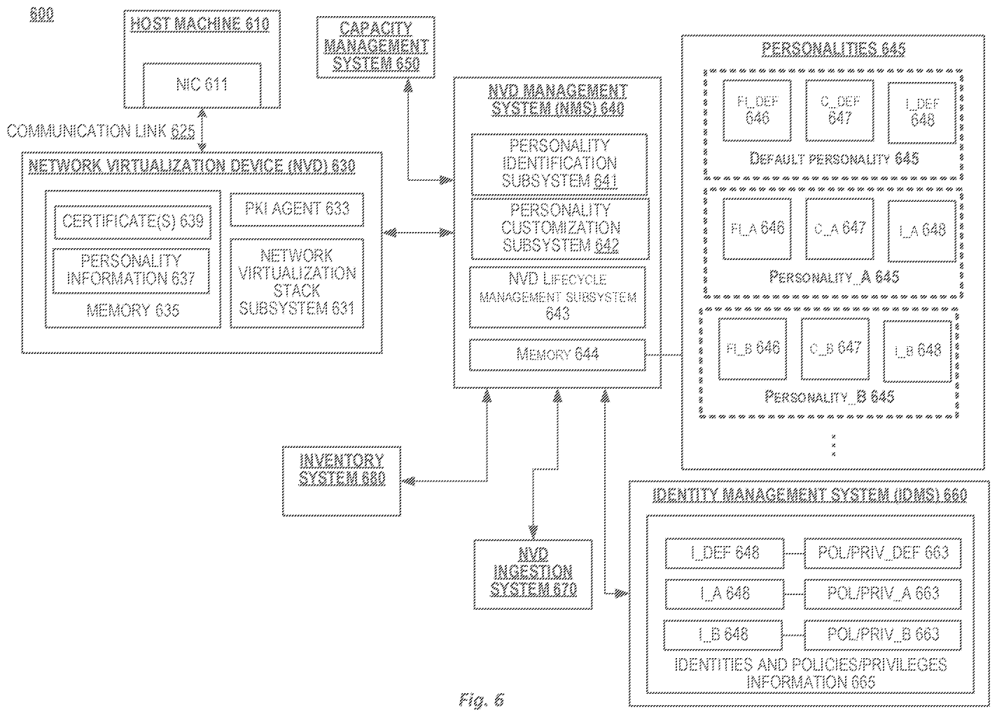

FIG. 6 depicts a computing environment 600 for binding a particular personality selected from a set of personalities to an NVD and provisioning the NVD, according to certain embodiments. The example computing environment 600 includes a host machine 610 that communicates with the NVD 630 via a network interface card (“NIC”) 611 and a communication link 625 (e.g., an Ethernet communication link 625). FIG. 2, FIG. 3, FIG. 4, and FIG. 5 herein describe example embodiments of host machines and NVDs. The NVD 630 communicates, via a network 620, with one or more computing systems, for example, an NVD management system (NMS) 640, an NVD ingestion system 650, and an identity management system (IDMS) 660 as depicted in FIG. 6.

The host machine 610 comprises a network interface card (“NIC”) 611. In certain examples, the NIC 611 includes one or more ports and enables communication between the host machine 610 and the NVD 630. Examples of NICs 611 include NIC 232, NIC 244, NIC 250 of FIG. 2, NIC 304 of FIG. 3, and NIC 410 of FIG. 4. NIC 611 may include functionalities and/or configurations of NICs described herein, including the NICs depicted in FIG. 1, FIG. 2, FIG. 3, FIG. 4. In certain embodiments, the host machine 610 executes a compute instance. The compute instance could either be a virtual machine or a bare metal instance as described herein, for example, in FIG. 2.

The NVD 630 may be a smart network interface card (smartNIC) that communicates with the host machine 610 via the NIC 611. An example NVD 630 includes a network virtualization stack subsystem 631, a public key infrastructure (“PKI”) agent 633, and a memory 635. The NVD 630 may comprise a similar architecture to (e.g., have similar components and subcomponents to) and perform functions or operations similar to network virtualization devices described herein, including one or more of NVD 210 and NVD 212 of FIG. 2, NVD 310 and NVD 312 of FIG. 3, NVD 412 of FIG. 4, or NVDs depicted in FIG. 5.

The network virtualization stack subsystem 631 may perform one or more of the functions or operations as performed by such network virtualization devices described herein, for example, functions or operations described herein as being performed by one or more of the NVD 210 and the NVD 212 of FIG. 2, the NVD 310 and the NVD 312 of FIG. 3, the NVD 412 of FIG. 4, or the NVDs of FIG. 5. For example, the network virtualization stack subsystem 631 may facilitate reception by the NVD 630 of packets and frames from the host machine 610 (e.g., packets and frames generated by a compute instance hosted by the host machine) via a host-facing port and, after performing the necessary packet processing, may forward the packets and frames to a TOR switch via a network-facing port of the NVD 630. The network virtualization stack subsystem 631 may facilitate reception by the NVD 630 of packets and frames from a TOR switch via a network-facing port of the NVD 630 and, after performing the necessary packet processing, may forward the packets and frames to a host machine via a host-facing port of the NVD 630. The network virtualization stack subsystem 631 may implement or perform network virtualization functions. These functions are performed by software/firmware executed by the NVD 630. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, the network virtualization stack subsystem 631 executes a packet processing pipeline for processing the packet and determining how the packet is to be forwarded or routed. As part of this packet processing pipeline, the network virtualization stack subsystem 631 may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions. In certain embodiments, the packet processing data path may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD 630. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines. The network virtualization stack subsystem 631 may perform both control plane and data plane functions corresponding to a control plane and a data plane of a VCN. In certain embodiments, the network virtualization stack subsystem 631 intercepts all network packets in and out of host machines and perform network virtualization functions. The network virtualization stack subsystem 631 may execute various virtualization functions including VNICs and VCN VRs. The network virtualization stack subsystem 631 may execute VNICs associated with the compute instances hosted by one or more host machines connected to the VNIC. The network virtualization stack subsystem 631 may execute VCN Virtual Routers corresponding to the VCNs of the compute instances. The network virtualization stack subsystem 631 may execute various software (e.g., daemons) and include one or more hardware components that facilitate the various network virtualization functions performed by the NVD 630. For purposes of simplicity, these various components are grouped together as “packet processing components” shown in FIG. 2.

An example PKI agent 633 communicates with a PKI subsystem 661 of the identity management system 660 to receive one or more certificates 639 associated with an identity associated with a personality bound to the NVD 630 by the NVD management system 640.

In certain embodiments, the NVD 630 stores personality information 637 and one or more certificates 639 in a memory 635. Personality information 637 includes a personality that has been bound to the NVD 630 by the NVD management system 640. A personality includes to (1) a firmware image, (2) a configuration (e.g., a count and bandwidth of TOR/uplink ports, a count and bandwidth of Host/downlink ports, a number of storage, physical, and virtual functions to expose, etc.), and (3) an identity, where (1), (2), and (3) are particular to the assigned personality. In certain embodiments, the NVD 630 communicates a request to the identity management system 660 and the identity management system 660 and the identity management system 660 approves the request responsive to authenticating and authorizing the NVD 630. In certain embodiments, the identity management system 660 authenticates the NVD 630 by authenticating a certificate 639 received from the NVD 630 corresponding to the identity. In certain embodiments, the authorizes the request by comparing one or more functions and/or one or more resources the NVD 630 is attempting to access in the request based on policies and/or privileges associated with the identity associated with the personality that the NVD management system 640 has bound to the NVD 630.

In certain embodiments, the NVD management system 640 is an NVD management service that manages a lifecycle of personalities for multiple NVDs 630 that are managed by the NVD management service. For any NVD 630 managed by the NVD management system 640, the NVD management system 640 is able to determine a personality bound to the NVD 630 as well as the host machine 610 to which the NVD 630 is attached.

In certain embodiments, the NVD management system (NMS) 640 comprises a personality identification subsystem 641, a personality customization subsystem 642, an NVD lifecycle management subsystem 643, and a memory 644, which stores information describing a set of available personalities 645.

The personality identification subsystem 641 can determine, from a set of available personalities 645, a particular personality 645 to bind to an NVD 630. A personality 645 corresponds to (1) a firmware image, (2) a configuration (e.g., a count and bandwidth of TOR/uplink ports, a count and bandwidth of Host/downlink ports, a number of storage, physical, and virtual functions to expose, or other capabilities for the NVD 630), and (3) an identity, where (1), (2), and (3) are particular to the personality 645. In certain embodiments, the personality assignment subsystem 641 can unbind a current personality 645 from the NVD 630 and bind a new personality (different from the current personality) to the NVD 630, where the new personality 645 is selected from the set of personalities 645. In certain embodiments, the personality assignment subsystem 641 selects, for binding to the NVD 630 and from the set of personalities 645, a particular personality 645 specified in a request received from the NVD 630. In other embodiments, the personality assignment subsystem 641 selects, for binding with the NVD 630 from the set of personalities 645, the particular personality 645 based on a computing environment of the NVD 630 and/or host machine 610 (e.g., the NVD 630 and/or the host machine 610 is being used in a service enclave, the NVD 630 and/or the host machine 610 is being used in a customer enclave, etc.). In other embodiments, the personality assignment subsystem 641 selects, for binding to the NVD 630 from the set of personalities 645, the particular personality 645 that provides a functionality based on information received by the personality assignment subsystem 641 regarding a functionality for the NVD 630. In other embodiments, the personality assignment subsystem 641 works in conjunction with a capacity management system 650, which indicates based on an existing capacity of servers, which functionality is to be configured for the NVD 630 and determines the particular personality 645 that provides the functionality.

In certain embodiments, the personality customization subsystem 642 (e.g., in response to receiving one or more inputs from an operator of the personality customization subsystem 642) configures the set of personalities 645 by defining the firmware image, configuration, and identity for each personality of the set of personalities. In certain embodiments, the personality customization subsystem 642 can (A) add a new personality 645 to the set of personalities 645 and configures the new personality 645, (B) delete or otherwise remove a personality 645 from the set of personalities 645, and/or (C) edit or reconfigure one or more aspects of a particular personality 645 of the set of personalities 645 (e.g., by modifying one or more of the firmware image, the configuration, or the identity).

In certain embodiments, the NVD lifecycle management subsystem 643 monitors status information of one or more NVDs 630. For example, the NVD lifecycle management subsystem 643 maintains status information indicating a locked status, an unlocked status, a bound personality status, an unbound personality status, a personality identifier, one or more timestamps with information concerning functions performed by the NVD 630.

The NMS 640 stores information associated with a set of personalities 645 in a memory 644. FIG. 6 illustrates an embodiment where the NMS 640 defines three personalities 645 (personality_A 645, personality_B 645, and a default personality 645), however, in certain embodiments, the NMS 640 defines a set of personalities 645 other than three (e.g., either greater than or less than the three personalities 645 depicted in FIG. 6). For example, the NMS 640 could define two personalities 645 (e, g., a personality_A 645 and a default personality 645), seven personalities (e.g., personalities A, B, C, D, E, F, and a default personality 645), ten personalities 645, or other number of personalities 645. In the example depicted in FIG. 6, where the NMS defines three personalities 645, the memory 644 includes stored information associated with a personality_A 645, a personality_B 645, and a default personality 645, as depicted in FIG. 6. Each of the personality_A 645, personality_B 645, and the default personality 645 includes a firmware image (FI) 646, configuration parameters (C) 647, and an identity (I) 648 stored in the memory 645. For example, as depicted in the example of FIG. 6, personality_A 645 includes a firmware image FI_A 646, configuration parameters C_A 647, and an identity I_A 648, personality_B 645 includes FI_B 646, C_B 647, and I_B 648, and the default personality 645 includes FI_def 646, C_def 647, and I_def.

Each personality 645 (e.g., A, B, and default) of the set of personalities 645 includes a firmware image 646 (e.g., FI_A 646, FI_B 646, and FI_def 646) associated with and unique to the respective personality. In certain embodiments, the firmware image 646 includes software to install on an NVD 630. The software in the firmware image 646 includes the PKI agent 633, which can enable the NVD 630 to communicate with an identity management system 660 to download certificates 639 related to an identity associated with the assigned personality of the NVD 630. In certain examples, the PKI agent 633 receives, from the NVD management system 640, updates one or more personality-related certificates 639 of the NVD 630.

Each personality 645 (e.g., A, B, and default) of the set of personalities 645 includes configuration parameters 647 (e.g., C_A 647, C_B 647, and C_def 647) associated with and unique to the respective personality 645. Configuration parameters 647 may include one or more of a count and bandwidth of TOR/uplink ports, a count and bandwidth of Host/downlink ports, a number of NVMe/storage PCIe physical and virtual functions to expose, or other capabilities which are configurable for the NVD 630.

Each personality 645 (e.g., A, B, and default) includes an identity 648 (e.g. I_A 648, I_B 648, and I_def 648), associated with and unique to the personality 645. In certain examples, the NVD 630 downloads, from the identity management system 660, certificates 639 associated with the identity of the NVD 630. In certain examples, the certificates 639 enable the NVD 630 to attest to its identity (and/or personality) and roles.

In certain embodiments, the NMS 640 communicates with a capacity management system 650, to receive inputs in the form of provisioning requests to the NMS 640 to provision a new NVD 630 that does not yet have a personality 645 bound to the NVD 630 or to provision a previously previsioned NVD 630 that already has a personality 645 bound to the NVD 630. In some embodiments, the provisioning request may identify a particular personality 645 to be bound to the NVD 630. In other embodiments, the provisioning request identifies an environment (e.g., a service enclave vs. a customer enclave) for which the provisioning of the NVD 630 is desired, and the NMS 630 selects a personality 645 from the set of personalities 645 best suited for the environment. In yet other embodiments, the provisioning request identifies a set of one or more functions for which the NVD 630 is being provisions, and the NMS 630 selects a personality from the set of personalities 645 best suited for performing the identified set of one or more functions. In certain embodiments, the capacity management system 650 monitors a capacity of servers (e.g., host machines 610) and associated NVDs 630 and determines what type of servers are needed (e.g., customer enclave servers or service enclave servers) and sends a request to the NMS 630 to provision an appropriate type of NVD 630 suitable to a type of server needed. For example, the type may include an identification of the particular personality 645 to be bound to the NVD 630, an indication of an environment of the host machine 610 and/or NVD 630, an indication of one or more desired functions of the NVD 630. In these examples, the information received from the capacity management system 650 that indicates a personality 645, environment, or functions of the NVD 630 is used by the NMS 660 (e.g., the personality identification subsystem 661) to select, by the NMS 660, a personality 645, from the set of personalities 645, to bind to the NVD 630.

The identity management system (IDMS) 660 stores credentials (e.g., certificates, logins/passwords, tokens, etc.) that are used to an NVD 630 to assert a particular personality that is bound to the NVD 630. The IDMS 660 stores identifies and policies/privileges information 665 including identities associated with each of the personalities 645 (of the set of personalities 645) and corresponding policies and privileges associated with each of the personalities 645. For example, the identities and policies/privileges information 665 includes, for three example identifies I_DEF 648, I_A 648, and I_B 648, POL/PRIV_DEF 663 associated with I_DEF 648, POL/PRIV_A 663 associated with I_B 648, and POL/PRIV_B 663 associated with I_C 648. A policy enumerates one or more privileges for a corresponding identity. In certain embodiments, the NMS 640 communicates with the IDMS 660 to receive credentials corresponding to a selected personality (from the set of personalities 645) to be bound to the NVD 630. The IDMS 660 may send the credentials corresponding to the particular personality 645 of the set of personalities 645 responsive to receiving a request from the NMS 640. In certain embodiments, the IDMS 660 performs authentication and authorization functions when an NVD 630 requests to perform a requested action or function. In certain examples, authentication includes checking if the credentials asserted by the NVD 630 correspond to a personality 645 asserted by the NVD 630. For example, if the credentials include a certificate 639, the IDMS 660 verifies if the request was signed using the correct certificate 639 associated with the personality 645 asserted by the NVD 630. In another example, if the credentials include a token, the IDMS 660 verifies that the correct token is included in the request sent by the NVD 640. Other types of credentials may also be used by the NVD 630 and verified by the IDMS 660 during authentication. Authorization by the IDMS 660 may include checking if a requested action/function is permitted for the NVD 630 for an asserted identity (corresponding to the personality asserted by the NVD 630). If the IDMS 660 determines that the NVD 630 is not authorized to perform a requested action/function, the IDMS 660 does not permit performance of the requested action/function.

In certain embodiments, the IDMS 660 includes a public key infrastructure (PKI) subsystem, and the NMS 640 integrates with the PKI subsystem to issue certificates 639 to each NVD 630 including a bound personality to attest to the NVD's 630 current location, affinitized resources, identity and/or roles. Issuance of this certificate 639 establishes a principal for the purpose of authentication and authorization of activities initiated by the NVD 630. The entitlements of this principal can be modulated by identity authorization policies. The NVD 630 uses this certificate for all communication to establish trust with other systems in the substrate. Since this certificate is tied to the current personality of the NVD 630, all authorization attempts will only work for actions that are aligned with the active and authorized role(s) of the identity associated with the bound personality. An NVD 630 attempting to act in a way that is not consistent with its current identity (and personality) will face authorization errors which will raise alarms.

In certain embodiments, the NMS 640 communicates with an NVD ingestion system 670 to ingest an NVD 630 to a data center. The NVD ingestion system 670 ingests the NVD 630 to the data center if the identity corresponding to the personality bound to the NVD 630 has a privilege that enables ingestion of the NVD 630. In an embodiment, after the NMS 640 has bound a default personality with an NVD 630, the NVS 630 transmits a request to the NVD ingestion system 670 to perform an ingestion of the NVD 630. In this embodiment, to ingest the NVD 630, the NVD ingestion system 670 checks the particular personality 645 (the default personality 645 in this example) bound to the NVD 630 and its corresponding identity, I_def 648. In this embodiment, the NVD ingestion system 670 communicates with the IDMS 660 and the IDMS 660 determines if ingestion is allowed for the identity. For example, the IDMS 660 determines if ingestion is a privilege associated with I_def 648 associated with the default personality.

In certain embodiments, the NMS 640 communicates with an inventory system 680. The inventory system 680 has accesses to an inventory of unprogrammed NVDs 630. In certain embodiments, when a new NVD 630 is to be used (e.g., the new NVD 630 is installed on a host machine 610), the inventory system 680 sends a signal to the NMS 640 that a new NVD 630 has been detected.

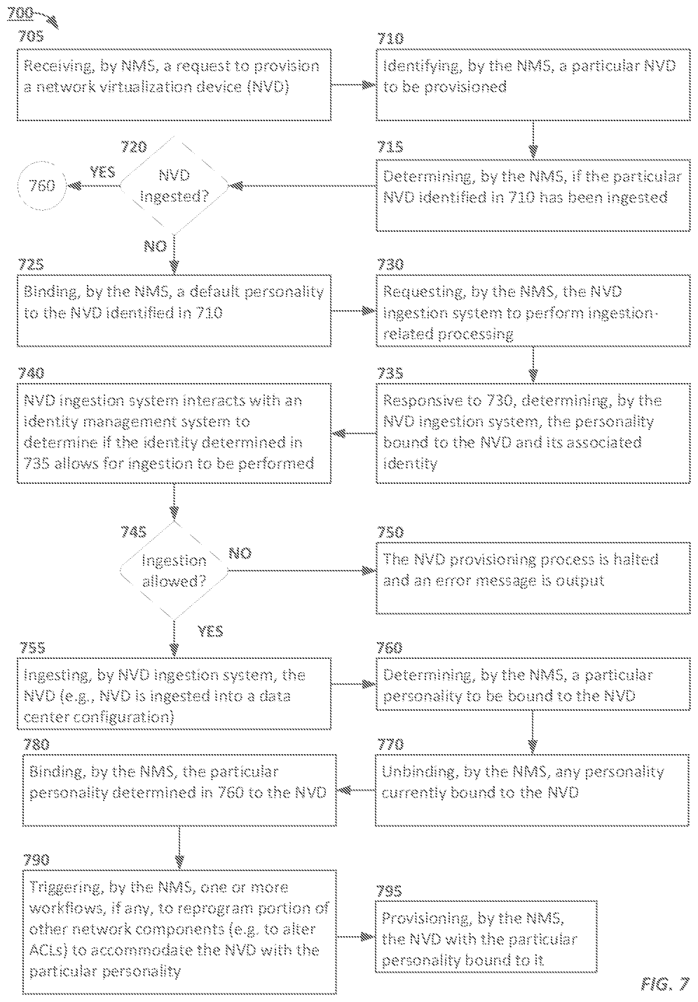

FIG. 7 depicts an example of a method 700 for binding a particular personality selected from a set of personalities to an NVD and provisioning the NVD, in accordance with certain embodiments described herein. The processing depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the processing may be performed in some different order, or some steps may also be performed in parallel.

For illustrative purposes, the method 700 is described with reference to the components illustrated in FIG. 6, although other implementations are possible. For example, in certain implementations, the program code implementing one or more of the systems and subsystems depicted in FIG. 2 may be stored on a non-transitory computer-readable medium and executed by one or more processing devices to provide the functionality depicted in FIG. 7 and described in the disclosure.

At block 705, processing may be initiated when the NMS 640 receives a request to provision a network virtualization device (NVD). In certain instances, request received in 705 may identify a specific NVD to be provisioned. The specific NVD to be provisioned may be identified, for example, by a unique identifier (e.g., a SKU), an address associated with the NVD (e.g., a MAC or an IP address), or using some other identifier. In some other instances, the request may be for an NVD to be provisioned without identifying a specific NVD. The request received in 705 may be for new NVD to be provisioned, which has never been provisioned before. Alternatively, the request in 705 may identify a previously provisioned NVD that is now to be reprovisioned.

The request received in 705 may also identify a set of functions for which the NVD is to be provisioned. In certain embodiments, the request received in 705 may identify a specific personality that is to be bound to the NVD as part of the provisioning.

The request in 705 may be received from various different sources. In certain instances, the request may be received from a user (e.g., a system administrator) of the NMS 640. For example, a user using a user device or via a central console system may author and send the request.

As another example, the request in 705 may be received from the capacity management system 650. For example, the capacity management system 650 may detect that a computing environment has too few NVDs 630 provisioned that are capable of providing a particular set of functions corresponding to a particular personality. In order to correct this imbalance, the capacity management system 650 may send a request to NMS 640 requesting a NVD to be provisioned with the particular set of functions. In certain instances, the request from the capacity management system 650 may identify a specific personality to be used for provisioning the NVD. In certain embodiments, the capacity management system 650 monitors a capacity of servers (e.g., host machines 610) and associated NVDs 630 and determines what type of servers are needed (e.g., customer enclave servers or service enclave servers) and sends a request to the NMS 630 to provision an NVD with the particular personality suitable to a type of server needed.

In certain instances, the capacity management system 650 may also identify a specific NVD to be reprovisioned. For example, continuing the above example, the capacity management system 650 may determine that there is an excess of NVDs providing a first set of functions that is different from the particular set of functions. In such a situation, the capacity management system 650 may identify that a specific NVD, currently providing the first set of functions and bound to a corresponding personality, is to be reprovisioned to provide the particular set of functions instead of the first set of functions. For example, in FIG. 6, NVD 630 is selected to be provisioned.

At block 710, responsive to the request received in 705, the NMS 640 identifies a particular NVD to be provisioned. The NVD identified in 710 may be a new NVD that has never been provisioned before or may be an NVD that has been previously provisioned and is now to be reprovisioned with a new personality to perform a different set of functions.

In instances where the request received in 705 identifies a specific NVD, for example, identified using an identifier (e.g., a SKU, a MAC address or other device hardware ID, or other information that uniquely identifies the particular NVD), that particular NVD is selected in 710 for provisioning. For example, the NMS 640 may interact with an inventory system 680, which may send the NMS 640 information regarding the particular NVD.

In other instances, the request received in 705 may not identify a specific NVD. In such situations, the NMS 640 may interact with the inventory system 680, which may identify a particular NVD to be provisioned. For example, the inventory system 680 may search a list of NVDs that are available to be provisioned, and select an NVD from this list to be provisioned. As part of this process, the inventory system, 680 may identify a new NVD that has not yet been provisioned or may identify a previously provisioned NVD that is now to be reprovisioned with a personality that is different from a personality that is currently bound to that NVD.

At block 715, the NMS 640 determines if the particular NVD selected in 710 has been previously ingested. Ingestion is a process by which the NVD ingestion system 670 integrates a new NVD into a list of provisioned components for a data center.

Generally, when a new component, such as an NVD, is to be provisioned, it is first ingested and then provisioned. Once ingested, it can be provisioned and/or reprovisioned multiple times. Ingestion is thus typically a one-time process for new components.

As part of the processing performed in 715 to determine if the NVD has been ingested, the NMS 640 may transmit a request to the NVD ingestion system 670 for an ingestion status of the NVD being checked. The NVD ingestion system 670 may then, based upon ingestion information accessible to it, determine whether the particular NVD has been previously ingested or not and send the ingestion status to the NMS 640. For example, it may be determined that the NVD being provisioned is a new NVD that has previously not been ingested or provisioned. Alternatively, it may be determined that the NVD being provisioned has previously been ingested.

Based upon the processing performed in 715, a check is made at block 720 to determine if the NVD being provisioned has been previously ingested or has not been ingested. If it is determined in 720 that the NVD has already been ingested, then processing continues with block 760, else (i.e., the NVD has not been ingested) processing continues with block 725.

At block 725, the NMS 640 binds a default personality to the NVD being provisioned. A default personality (also referred to as a pass through personality) is a personality that enables a reduced set of functions to be performed on the NVD and to be performed by the NVD, where these reduced set of functions are used for further provisioning of the NVD.

For example, as shown in FIG. 6, a default personality 645 may be bound to the NVD being provisioned (e.g., NVD 630 in FIG. 6). Like with all personalities 645, the default personality 645 includes a firmware image FI_DEF 646, a set of configurations C_DEF 647, and an identity I_DEF 648. The firmware image FI_DEF 646 may include software or code that enables a certain set of reduced or basic functions. Configurations C_DEF 647 may comprise configuration settings for a set of configuration options. Default identity 648 may have a reduced set of privileges (e.g., policies/privileges 663 depicted in FIG. 6) that allow certain basic operations to be performed. Thus, taken together, firmware image I_DEF 646, configuration C_DEF 647, and identify I_DEF 648 may enable a certain reduced or basis set of functions to be performed by an NVD that has the default personality 645 bound to it. In certain implementations, this basic set of functions may permit communications with the NMS 640 and NVD ingestion system 650 but not include the ability to perform packet forwarding functions.

As part of the processing performed in 725, the NMS 640 may download the default personality 645, including its firmware image, set of configurations, and default identity, to the NVD being provisioned. The configurations on the NMS 640 may be set per the set of default configurations. In certain examples, the default identity 648 may have certain associated certificates or credentials associated with it that are downloaded and installed on the NVD as part of the processing performed in 725. Working in conjunction with identity management system 660, the NMS 640 may receive these one or more certificates from the IDMS 660 and then issue them to the NVD being provisioned as part of binding the default personality 645.

At block 730, the NMS 640 sends a request to the NVD ingestion system 650 to perform ingestion-related processing for the NVD. Ingestion-related processing is then performed corresponding to blocks 735, 740, 745, and 755.

At block 735, the NVD ingestion system 650 determines the personality that is currently bound to the NVD to be ingested. Since the default personality has been bound to the NVD in 725, the NVD ingestion system 650 will determine that the default personality 645 is bound to the NVD. The NMS 640 then determines the default identity 648 that is associated with the default personality 645. In certain implementations, the NVD ingestion system 650 may receive this information from the NMS 640 in response sent by the NVD ingestion system 650 to NMS 640.

At block 740, the NVD ingestion system 650 may determine if ingestion is permitted for the that NVD. In certain embodiments, this may be determined based upon the default identity 648 associated with the default personality 645 determined in 735. The NVD ingestion system may communicate with an identity management system (IDMS) 660 to determine if the default identity 648 determined in 735 allows for ingestion to be performed for the NVD.

As described above, the default personality 645 allows a basic set of functions for the NVD to which the default personality 645 is bound. In certain embodiments, this basic set of functions includes the ingestion function to be performed for the NVD to which the default personality 645 is bound.

At block 745, based upon the processing performed in 740, the NVD ingestion system 650 determines, based on the identity 648 of the NVD associated with its bound personality 645, whether ingestion is allowed or not allowed for the NVD. If it is determined in 745 that ingestion is allowed, then processing continues with block 755. Else, if it determined in 745 that ingestion is not allowed based upon the personality 645 bound to the NVD, then processing continues with block 750 wherein the provisioning process is halted, and an error message may be output to the requesting user indicating a reason for the process being halted. In certain embodiments, as part of the processing in 750, the NVD ingestion system 650 may send an error message to the NMS 640 indicating that ingestion is not allowed for the NVD based upon the personality 645 currently bound to the NVD. The NMS 640 may then halt the provisioning process and send an error message to the source of the provisioning request received in 705.

At block 755, the NVD ingestion system 650 ingests the NVD. In certain embodiments, ingestion is a process by which the NVD is added to the infrastructure for a data center.

At block 760, the NMS 640 determines a particular personality 645 that is to be bound to the NVD being provisioned (or reprovisioned). There are various ways in which the NMS 640 may determine the particular personality 645 to be bound to the NVD. As described above, in some instances, the provisioning request received at block 705 may identify the particular personality 645 to be bound to the NVD being provisioned. In such scenarios, that particular specified personality 645 is selected in 760 to be bound to the NVD.

In other instances, the provisioning request may identify an environment (e.g., a service enclave vs. a customer enclave) in which the provisioned NVD is to operate in or may identify a specific functional behavior characterized by a specific set of one or more functions for which the NVD is being provisioned. As part of the processing performed in 760, the NMS 630 selects, from a set of personalities 645, a personality 645 that is best suited for the specific environment in which the NVD is to operate or best suited, i.e., a personality 645 that provide a functional behavior that is suited for that environment. For example, the request received in 705 may specify that an NVD is to be provisioned for a Customer Enclave server. Then in 715, the NMS 640 identifies a personality 645 corresponding to customer enclave functionality. If a particular functional behavior or a set of functions is specified, an appropriate personality 645 is selected that provides the desired functional behavior and the set of functions. For example, a special purpose use-case includes an asymmetric number of TOR ports versus downlink ports.

At block 770, the NMS 640 determines if there is any personality 645 currently bound to the NVD, and if so, unbinds that personality 645. In certain embodiments, unbinding a personality 645 bound to the NVD comprises transmitting instructions to the NVD to delete all information relating to the currently bound personality 645 including the firmware image of the personality 645, the configuration settings of the personality 645, and the identity of the personality 645, and other information stored on the NVD that is associated with the bound personality 645. Unbinding deletes all information related to the personality 645 being unbound from the NVD. The instructions may include instructions to delete software included in the firmware image 646, for example, the PKI agent 633. As part of 770, the NMS 640 may also log information identifying the personality 645 that is unbound and the time when the unbinding was done.

At block 780, the NMS 640 binds the particular personality 645 determined in 760 to the NVD. In certain embodiments, the processing performed in 780 includes sending the particular personality 645 related information to the NVD and installing the information on the NVD and/or configuring the NVD based upon the personality 645 information. The personality-related information may include a firmware image, configuration parameters, and an identity associated with the particular personality 645. For example, if personality_B 645 depicted in FIG. 1 is to be bound to NVD, the personality-related information that is sent to NVD includes a firmware image FI_B 646, configuration parameters C_B 647, and an identity I_B 648. The firmware image may be downloaded and installed on NVD. As part of installing the firmware image, an agent (e.g., Public Key Infrastructure (PKI) agent 633) may be installed on NVD.

The NVD and its components (e.g., ports) may be configured per the configuration information included in the particular personality 645 information. The set of configurations defined for a personality 645 may specify a specific set of configuration parameters and associated values, where these configuration parameters influence the functioning of the NVD or components of the NVD. For example, with respect to the ports on an NVD, the configuration information defined for a personality 645 may specify parameters and associated values that control the number of active ports of the NVD, which ports are to be active, the bandwidths configured for the ports, which ports are to be uplink ports versus downlink ports, and the like. Configuration settings may also be defined for other aspects of the NVD such as storage configurations for the NVD such as the amount of available storage, number of NVMe/storage or PCIe physical and virtual functions to expose, and the like.

As part of the binding, the identity included in the bound personality is associated with the NVD. For example, for personality B being bound to NVD, identity 648 is associated with NVD. In certain embodiments, the NMS 640 may inform IDMS 660 that personality B and identify 648 is bound to NVD. In certain embodiments, PKI agent 633 that is downloaded and installed on NVD as part of the firmware image install may facilitate downloading of the appropriate credentials and/or certificates associated with identity 648 to NVD. In certain embodiments, these credentials and/or certificate may be sent by IDMS 660 to NMS 640, which in turn then downloads them to NVD.

At block 790, one or more workflows, if any, are performed to reprogram one or more other network components to accommodate the NVD with the particular personality 645. For example, depending upon the personality 645 that is bound to the NVD and the functional behavior of the NVD resulting from that personality 645 being bound to the NVD, the NMS 640 triggers workflows that reprogram network components of the physical network to alter access control lists (ACLs) to make previously inaccessible network communication accessible, or vice-versa, as part of NVD personality change workflows.

At block 795, the NMS 640 then completes the provisioning of the NVD. For example, as part of the processing performed in 795, the NVD, now bound to a personality 645, maybe associated with a particular host machine or server. The NMS 640 may store/log information related to the provisioning. This information may include, for example, information identifying the personality 645 that has been bound to the NVD, the time was the binding was performed, the host machine 610 that is associated with the NVD, and the like. NMS 640 may also send a message to the sender of the provisioning request received in 705 that the NVD has been successfully provisioned. In another example, the NMS 640 receives, from the sender of the provisioning request received in 705, a request for a provisioning status. In this other example, the NMS 640 transmits, responsive to receiving the request for the provisioning status, the message to the sender that the NVD has been successfully provisioned.

In certain embodiments, a personality 645 that is bound to an NVD may be locked when the personality 645 is bound to the NVD by the NMS 630. In such a situation, in order for that personality 645 to be unbound from the NVD, the personality 645 has to be first unlocked. There are various reasons for locking a personality 645. For example, locking a personality 645 that is bound to an NVD put restrictions on that NVD—the locked personality 645 has to be unlocked before it can be unbound and a new personality 645 bound to the NVD. This may enable a personality 645 bound to an NVD from being changed. The ability to unlock a bound personality 645 may be restricted to only certain entities with the appropriate “key” to unlock the lock. Thus, locking can be used to prevent accidental unbinding. Locked personalities 645 must first be unlocked before they can be unbound from the NVD. In certain use cases, this enables a service that is managing a host machine 610, to prevent recycling the personality 645 bound to an NVD while certain conditions are prevalent (e.g., the attached bare metal host is occupied by a bare-metal instance).

As described above, the functions that an NVD can perform can be changed by binding different personalities to the NVD. The NVD can thus be used for different use cases and in different environments in a cloud infrastructure, as desired, thereby increasing its versatility. The ability to bind, unbind, and rebind personalities to an NVD may be provided as a service in a cloud environment. For example, in a cloud infrastructure providing IaaS services, this ability may be provided and used to change the functionality of NVDs deployed and used in the cloud infrastructure. The following section shows an example of an IaaS infrastructure in which binding and unbinding of personalities 645 is provided.

### Example Embodiment

A next generation NVD (e.g., a smart NIC or smartNIC) platform is described that is capable of being configured in a variety of ways depending on use-case. In certain implementations, it can combine the host's existing smart NIC functionality with the offloading functionality associated with present day smart NICs on the same PCIe card securely, essentially at no extra cost. This allows the same smart NIC to be used in passthrough mode as if it were a COTS NIC, while also being able to reconfigure it to offload storage, security and network workloads off the main CPU. Because they can be configured in a variety of ways, the NVDs can also be reconfigured with different features enabled on the fly to serve purpose-specific needs.

The enhanced NVDs solve several problems. Cloud Infrastructure Capacity Management systems would like to reduce the number of hardware SKUs managed for efficiency. This requires eliminating special purpose SKUs such as Service Enclave racks which need no smart NICs. Ideally, a NIC can be dynamically configured as late in the game as possible, in ways that make it work as a “dumb” NIC when in use, for example, in Service Enclave workloads and as a smart NIC when in use, for example, in Customer Enclave workloads. Such a capability makes rack SKUs more fungible, allowing for improved supply chain efficiencies.

Allowing smart NICs to change behavior so drastically could pose security concerns around ensuring that they are always configured to behave as their assigned roles dictate. This is handled by associating identities with the personalities.

A smart NIC Management Service (NMS) is described, that manages the lifecycle of smart NIC Personalities. In certain implementations, a smart NIC Personality is defined by the firmware image and configuration, as well as its role and identity when it is in operation.

For any given smart NIC in a cloud infrastructure region, NMS will be able to describe the Personality of the smart NIC, i.e., what firmware image is running, what server (e.g., host machine) the smart NIC is attached to, the desired configuration and roles, and the active valid Identity principals and certificates associated with the personality that is bound to the smart NIC.

NMS will integrate with the PKI (Public Key Infrastructure) system to issue certificates to each smart NIC Personality to attest to the smart NIC's current location, affinitized resources, identity, and roles. Issuance of this certificate establishes a Principal for the purpose of authentication and authorization of activities initiated by the smart NIC. The entitlements of this Principal can be modulated by Identity authorization policies. In certain implementations, the smart NIC will use this certificate for all communications to establish trust with other systems in the substrate network. Since this certificate is tied to the current Personality of the smart NIC, all authorization attempts will only work for actions that are aligned with the active and authorized role(s) of the smart NIC. A smart NIC attempting to act in a way that is not consistent with its current Personality will face authorization errors which will raise the right alarms. In certain implementations, a PKI agent on the smart NIC will install, and periodically refresh certificates.

An example step-by-step walkthrough of a common usage scenario is outlined below:

1. NMS discovers new smart NICs from inventory service (e.g., from Storekeeper)
a. At this time, the smart NIC has no associated Personality.
b. In certain implementations, a smart NIC with no Personality passes no traffic and is untrusted.

2. NMS creates and binds a Passthrough Personality to new smart NIC to enable ingestion.

3. New smart NIC goes through normal ingestion and wipe process (e.g., via the HOPS system).

4. NMS gets called to create and bind a Personality to the smart NIC (e.g., a Substrate Personality when the smart NIC is to be used in the substrate network).
a. In certain implementations, this involves first unbinding and deleting any previously bound Personality.
b. The smart NIC gets assigned a new set of attributes:
   i. Firmware image—contains a PKI agent that installs and periodically updates installed Personality-related certs.
   ii. Configuration including, for example:
      1. Count and bandwidth of TOR/uplink ports
      2. Count and bandwidth of Host/downlink ports
      3. number of NVMe/storage PCIe physical and virtual functions to expose, etc.
   iii. Certificates (which enable the smart NIC attest its Personality and role(s))
c. The smart NIC then gets provisioned with the assigned attributes (in certain implementations, NMS Data Plane through HOPS does the provisioning)

5. NMS may get called to lock a bound Personality to prevent accidental unbinding. Locked Personalities must first be unlocked before they can be unbound from a smart NIC and deleted. This enables a service that is managing the entire server, e.g., Compute, to prevent recycling the Personality of a smart NIC while the attached bare metal host is occupied by a bare-metal instance.

6. The NMS API may be called to bind a new Personality to a smart NIC.
a. In certain implementations, binding a new Personality requires that no Personality is currently bound.
b. Unbinding a Personality requires that it is not currently locked.
c. To bind a new Personality to the smart NIC of an occupied server, we need to evict the occupants and then unlock, unbind and delete the Personality bound to the smart NIC.

7. Suppose we want to reconfigure a smart NIC on a Customer Enclave server for a special purpose use-case. Suppose for example, that we would like to configure it with an asymmetric number of TOR ports versus downlink ports. This can be achieved by deleting the old Personality and binding a new Personality that specifies the asymmetric ports and whatever other bespoke configuration that is desired. Any authorization policy differences would be pre-defined and established in the authorization system(s). Upon binding the new Personality, the smart NIC will present with different behavior to match the desired need.

8. In some embodiments, workflows may be triggered that reprogram portions of the physical network to alter ACLs to make previously inaccessible network communication accessible, or vice-versa, as part of smart NIC Personality change workflows.

NIC Personalities allow use of the same rack SKUs for substrate and overlay workloads.

Example Infrastructure as a Service (Iaas) Architecture

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

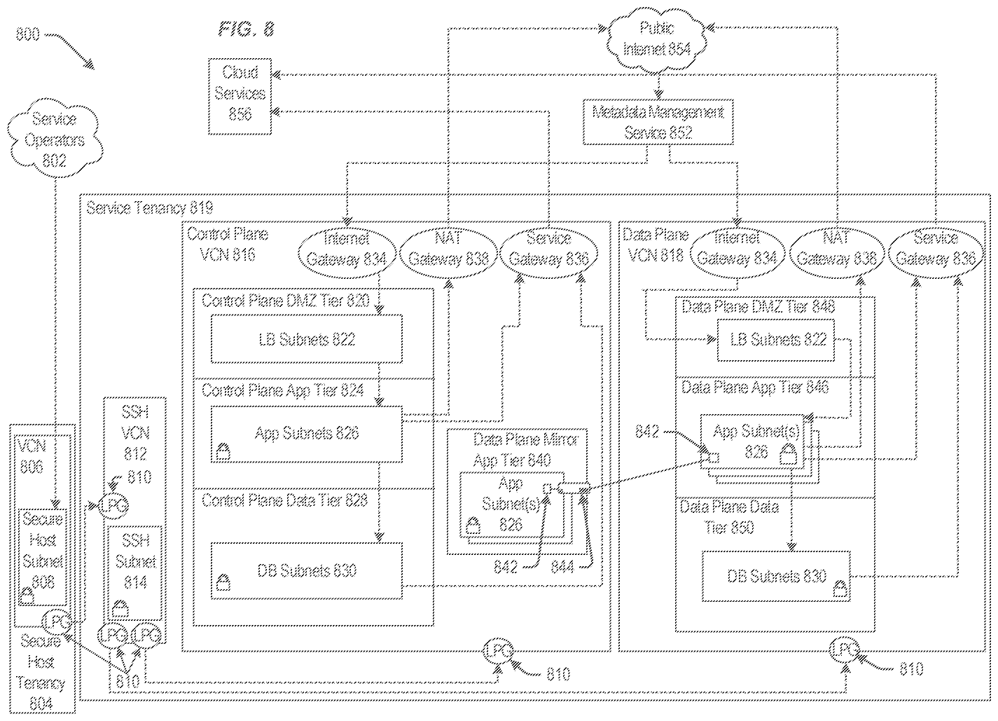

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Memory that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

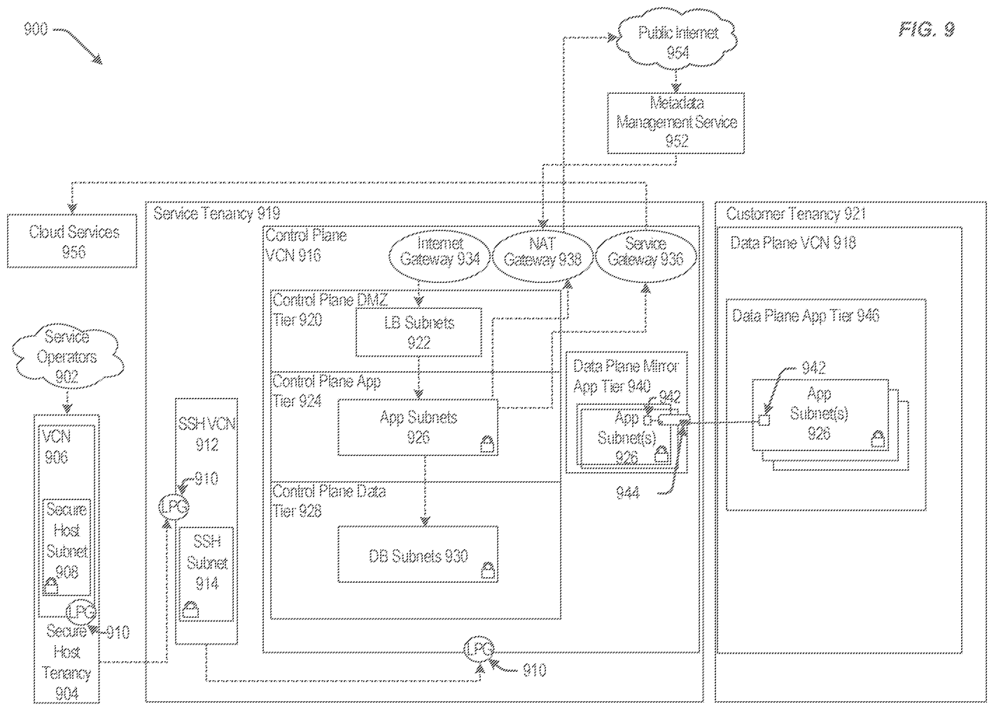

FIG. 9 is a block diagram 900 illustrating another example pattern of an IaaS architecture, according to at least one embodiment. Service operators 902 (e.g. service operators 802 of FIG. 8) can be communicatively coupled to a secure host tenancy 904 (e.g. the secure host tenancy 804 of FIG. 8) that can include a virtual cloud network (VCN) 906 (e.g. the VCN 806 of FIG. 8) and a secure host subnet 908 (e.g. the secure host subnet 808 of FIG. 8). The VCN 906 can include a local peering gateway (LPG) 910 (e.g. the LPG 810 of FIG. 8) that can be communicatively coupled to a secure shell (SSH) VCN 912 (e.g. the SSH VCN 812 of FIG. 8) via an LPG 810 contained in the SSH VCN 912. The SSH VCN 912 can include an SSH subnet 914 (e.g. the SSH subnet 814 of FIG. 8), and the SSH VCN 912 can be communicatively coupled to a control plane VCN 916 (e.g. the control plane VCN 816 of FIG. 8) via an LPG 910 contained in the control plane VCN 916. The control plane VCN 916 can be contained in a service tenancy 919 (e.g. the service tenancy 819 of FIG. 8), and the data plane VCN 918 (e.g. the data plane VCN 818 of FIG. 8) can be contained in a customer tenancy 921 that may be owned or operated by users, or customers, of the system.

The control plane VCN 916 can include a control plane DMZ tier 920 (e.g. the control plane DMZ tier 820 of FIG. 8) that can include LB subnet(s) 922 (e.g. LB subnet(s) 822 of FIG. 8), a control plane app tier 924 (e.g. the control plane app tier 824 of FIG. 8) that can include app subnet(s) 926 (e.g. app subnet(s) 826 of FIG. 8), a control plane data tier 928 (e.g. the control plane data tier 828 of FIG. 8) that can include database (DB) subnet(s) 930 (e.g. similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g. the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g. the service gateway of FIG. 8) and a network address translation (NAT) gateway 938 (e.g. the NAT gateway 838 of FIG. 8). The control plane VCN 916 can include the service gateway 936 and the NAT gateway 938.

The control plane VCN 916 can include a data plane mirror app tier 940 (e.g. the data plane mirror app tier 840 of FIG. 8) that can include app subnet(s) 926. The app subnet(s) 926 contained in the data plane mirror app tier 940 can include a virtual network interface controller (VNIC) 942 (e.g. the VNIC of 842) that can execute a compute instance 944 (e.g. similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g. the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g. the metadata management service 852 of FIG. 8) that can be communicatively coupled to public Internet 954 (e.g. public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g. cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 11,” may be located in Region 1 and in “Region 2.” If a call to Deployment 11 is made by the service gateway 936 contained in the control plane VCN 916 located in Region 1, the call may be transmitted to Deployment 11 in Region 1. In this example, the control plane VCN 916, or Deployment 11 in Region 1, may not be communicatively coupled to, or otherwise in communication with, Deployment 11 in Region 2.

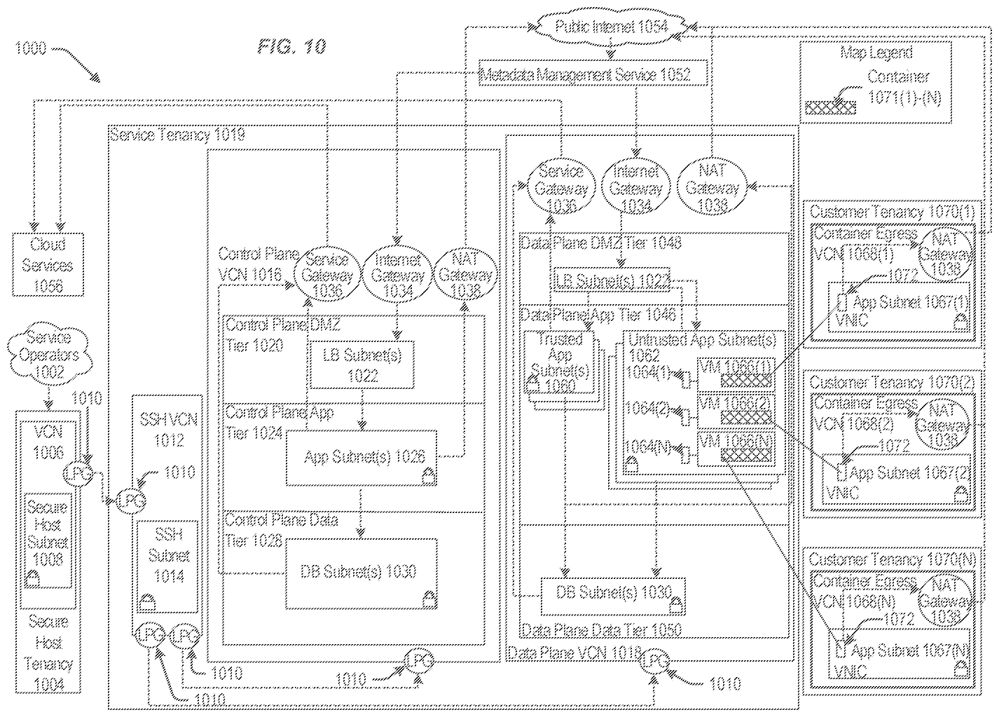

FIG. 10 is a block diagram 1000 illustrating another example pattern of an IaaS architecture, according to at least one embodiment. Service operators 1002 (e.g. service operators 802 of FIG. 8) can be communicatively coupled to a secure host tenancy 1004 (e.g. the secure host tenancy 804 of FIG. 8) that can include a virtual cloud network (VCN) 1006 (e.g. the VCN 806 of FIG. 8) and a secure host subnet 1008 (e.g. the secure host subnet 808 of FIG. 8). The VCN 1006 can include an LPG 1010 (e.g. the LPG 810 of FIG. 8) that can be communicatively coupled to an SSH VCN 1012 (e.g. the SSH VCN 812 of FIG. 8) via an LPG 1010 contained in the SSH VCN 1012. The SSH VCN 1012 can include an SSH subnet 1014 (e.g. the SSH subnet 814 of FIG. 8), and the SSH VCN 1012 can be communicatively coupled to a control plane VCN 1016 (e.g. the control plane VCN 816 of FIG. 8) via an LPG 1010 contained in the control plane VCN 1016 and to a data plane VCN 1018 (e.g. the data plane 818 of FIG. 8) via an LPG 1010 contained in the data plane VCN 1018. The control plane VCN 1016 and the data plane VCN 1018 can be contained in a service tenancy 1019 (e.g. the service tenancy 819 of FIG. 8).

The control plane VCN 1016 can include a control plane DMZ tier 1020 (e.g. the control plane DMZ tier 820 of FIG. 8) that can include load balancer (LB) subnet(s) 1022 (e.g. LB subnet(s) 822 of FIG. 8), a control plane app tier 1024 (e.g. the control plane app tier 824 of FIG. 8) that can include app subnet(s) 1026 (e.g. similar to app subnet(s) 826 of FIG. 8), a control plane data tier 1028 (e.g. the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g. the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g. the service gateway of FIG. 8) and a network address translation (NAT) gateway 1038 (e.g. the NAT gateway 838 of FIG. 8). The control plane VCN 1016 can include the service gateway 1036 and the NAT gateway 1038.

The data plane VCN 1018 can include a data plane app tier 1046 (e.g. the data plane app tier 846 of FIG. 8), a data plane DMZ tier 1048 (e.g. the data plane DMZ tier 848 of FIG. 8), and a data plane data tier 1050 (e.g. the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g. public Internet 854 of FIG. 8).

The Internet gateway 1034 contained in the control plane VCN 1016 and contained in the data plane VCN 1018 can be communicatively coupled to a metadata management service 1052 (e.g. the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

FIG. 11 is a block diagram 1100 illustrating another example pattern of an IaaS architecture, according to at least one embodiment. Service operators 1102 (e.g. service operators 802 of FIG. 8) can be communicatively coupled to a secure host tenancy 1104 (e.g. the secure host tenancy 804 of FIG. 8) that can include a virtual cloud network (VCN) 1106 (e.g. the VCN 806 of FIG. 8) and a secure host subnet 1108 (e.g. the secure host subnet 808 of FIG. 8). The VCN 1106 can include an LPG 1110 (e.g. the LPG 810 of FIG. 8) that can be communicatively coupled to an SSH VCN 1112 (e.g. the SSH VCN 812 of FIG. 8) via an LPG 1110 contained in the SSH VCN 1112. The SSH VCN 1112 can include an SSH subnet 1114 (e.g. the SSH subnet 814 of FIG. 8), and the SSH VCN 1112 can be communicatively coupled to a control plane VCN 1116 (e.g. the control plane VCN 816 of FIG. 8) via an LPG 1110 contained in the control plane VCN 1116 and to a data plane VCN 1118 (e.g. the data plane 818 of FIG. 8) via an LPG 1110 contained in the data plane VCN 1118. The control plane VCN 1116 and the data plane VCN 1118 can be contained in a service tenancy 1119 (e.g. the service tenancy 819 of FIG. 8).

The control plane VCN 1116 can include a control plane DMZ tier 1120 (e.g. the control plane DMZ tier 820 of FIG. 8) that can include LB subnet(s) 1122 (e.g. LB subnet(s) 822 of FIG. 8), a control plane app tier 1124 (e.g. the control plane app tier 824 of FIG. 8) that can include app subnet(s) 1126 (e.g. app subnet(s) 826 of FIG. 8), a control plane data tier 1128 (e.g. the control plane data tier 828 of FIG. 8) that can include DB subnet(s) 1130 (e.g. DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g. the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g. the service gateway of FIG. 8) and a network address translation (NAT) gateway 1138 (e.g. the NAT gateway 838 of FIG. 8). The control plane VCN 1116 can include the service gateway 1136 and the NAT gateway 1138.

The data plane VCN 1118 can include a data plane app tier 1146 (e.g. the data plane app tier 846 of FIG. 8), a data plane DMZ tier 1148 (e.g. the data plane DMZ tier 848 of FIG. 8), and a data plane data tier 1150 (e.g. the data plane data tier 850 of FIG. 8). The data plane DMZ tier 1148 can include LB subnet(s) 1122 that can be communicatively coupled to trusted app subnet(s) 1160 (e.g. trusted app subnet(s) 1060 of FIG. 10) and untrusted app subnet(s) 1162 (e.g. untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g. public Internet 854 of FIG. 8).

The Internet gateway 1134 contained in the control plane VCN 1116 and contained in the data plane VCN 1118 can be communicatively coupled to a metadata management service 1152 (e.g. the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

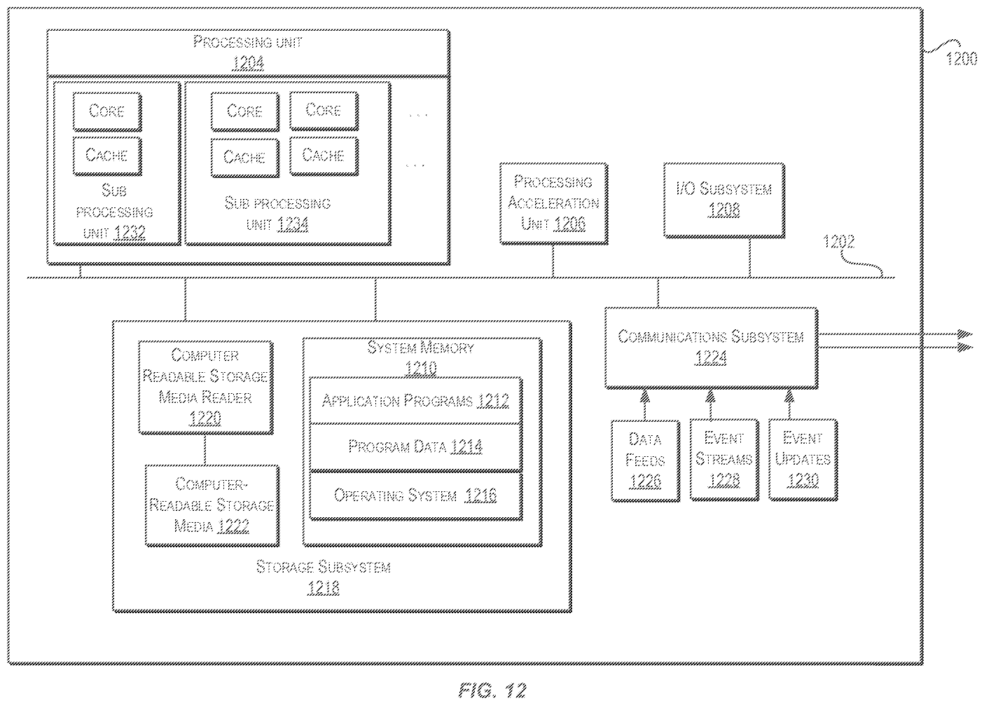

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A method performed by a network virtualization device management system, comprising:
determining, from a set of personalities, a first personality to be bound to a network virtualization device (NVD), the first personality defining a first identity for the NVD associated with a first set of policies and privileges;
unbinding a second personality bound to the NVD, wherein the second personality defines a second identity for the NVD associated with a second set of policies and privileges; and
binding the first personality to the NVD.

2. The method of claim 1,
wherein the first personality is configured to cause the NVD to have a first functional behavior characterized by a first set of functions, the first set of functions including a first network virtualization function,
wherein the second personality is configured to cause the NVD to have a second functional behavior characterized by a second set of functions, the second set of functions including a second network virtualization function, and
wherein the second set of functions is different from the first set of functions.

3. The method of claim 2, further comprising:
receiving information identifying a first functional behavior for the NVD; and
identifying, based upon the first functional behavior, the first personality that provides the first functional behavior.

4. The method of claim 1, wherein the second personality comprises a default personality and wherein the second set of policies and privileges comprises a restricted subset of the first set of policies and privileges.

5. The method of claim 1, further comprising:
at a time prior to determining the first personality to be bound to the NVD:
receiving a request to provision a particular network virtualization device (NVD);
responsive to determining that the particular NVD is ingested, binding the first personality to the particular NVD; and
ingesting the NVD into a data center.

6. The method of claim 5, wherein the request to provision a NVD includes an indication of the first personality, and wherein determining the first personality to be bound to the NVD comprises determining that the request includes the indication of the first personality.

7. The method of claim 6, wherein the request is received from a capacity management system, wherein the capacity management system indicates, in the request, the first personality in response to determining that a computing system including a host machine has a need for an NVD with the first personality.

8. The method of claim 5, wherein the request to provision the NVD includes an indication of a computing environment of one or more of the NVD or a host machine, and wherein the first personality to be bound to the NVD is determined based on the computing environment.

9. The method of claim 1, wherein binding the first personality comprises transmitting, to the NVD, instructions to install, on the NVD, a first firmware image corresponding to the first personality, first configuration information corresponding to the first personality, and the first identity corresponding to the first personality.

10. The method of claim 9, wherein an identity management system receives a request of the network virtualization device to access a resource, wherein the identity management system approves the request to access the resource responsive to:
receiving, by the identity management system, the first identity of the network virtualization device; and
determining, by the identity management system, that first set of policies and privileges associated with the first identity include access to the resource.

11. The method of claim 10, wherein the request to access the resource comprises a first certificate corresponding to the first identity and wherein approving the request to access the resource is further in response to authenticating, by the identity management system, the first certificate.

12. The method of claim 1, wherein unbinding the second personality comprises transmitting, to the NVD, instructions to uninstall or remove, from the NVD, a second firmware image corresponding to the second personality, second configuration information corresponding to the second personality, and the second identity corresponding to the second personality.

13. The method of claim 1, further comprising receiving, from a capacity management system, a request to provision an NVD with the first personality, wherein determining the first personality to be bound to a network virtualization device (NVD) comprises:
receiving, from a capacity management system, an indication of the first personality

14. A system, comprising:
one or more processors; and
a non-transitory computer-readable storage medium comprising computer-executable instructions that, when executed by the processor, cause the system to:
determining, from a set of personalities, a first personality to be bound to a network virtualization device (NVD), wherein the first personality defines a first identity for the NVD associated with a first set of policies and privileges;
unbinding a second personality bound to the NVD, wherein the second personality defines a second identity for the NVD associated with a second set of policies and privileges;
binding the first personality to the NVD; and
provisioning the NVD by associating the NVD with a host machine.

15. The system of claim 14,
wherein the first personality is configured to cause the NVD to have a first functional behavior characterized by a first set of functions, the first set of functions including a first network virtualization function,
wherein the second personality is configured to cause the NVD to have a second functional behavior characterized by a second set of functions, the second set of functions including a second network virtualization function, and
wherein the second set of functions is different from the first set of functions.

16. The system of claim 14, wherein the second personality comprises a default personality and wherein the second set of policies and privileges comprises a restricted subset of the first set of policies and privileges.

17. The system of claim 14, the non-transitory computer-readable medium further comprising instructions that, when executed by the one or more processors, cause the system to, at a time prior to determining the first personality to be bound to the NVD:
receive a request to provision a particular network virtualization device (NVD);
responsive to determining that the particular NVD is ingested, bind the first personality to the particular NVD; and
ingest the NVD into a data center.

18. The system of claim 13, wherein binding the first personality comprises transmitting, to the NVD, instructions to install, on the NVD, a first firmware image corresponding to the first personality, first configuration information corresponding to the first personality, and the first identity corresponding to the first personality.

19. A non-transitory computer-readable storage medium comprising computer-executable instructions that when executed by a processor of a network virtualization device, cause the processor to perform operations comprising:
determining, from a set of personalities, a first personality to be bound to a network virtualization device (NVD), wherein the first personality defines a first identity for the NVD associated with a first set of policies and privileges;
unbinding a second personality bound to the NVD, wherein the second personality defines a second identity for the NVD associated with a second set of policies and privileges;
binding the first personality to the NVD; and
provisioning the NVD by associating the NVD with a host machine.

20. The non-transitory computer-readable storage medium of claim 19,
wherein the first personality is configured to cause the NVD to have a first functional behavior characterized by a first set of functions, the first set of functions including a first network virtualization function,
wherein the second personality is configured to cause the NVD to have a second functional behavior characterized by a second set of functions, the second set of functions including a second network virtualization function, and
wherein the second set of functions is different from the first set of functions.
